(19) United States
(12) Patent Application Publication
(10) Pub. No.: US 2013/0255796 A1
(43) Pub. Date: Oct. 3, 2013

(54) FLOW-CONTROL DEVICE, COMPONENT HAVING A FLOW-CONTROL DEVICE, AND METHOD OF PRODUCING A FLOW-CONTROL DEVICE

(71) Applicant: GENERAL ELECTRIC COMPANY, Schenectady, NY (US)

(72) Inventors: Paul Stephen DIMASCIO, Greer, SC (US); Rebecca Evelyn HEFNER, Fountain Inn, SC (US)

(73) Assignee: GENERAL ELECTRIC COMPANY, Schenectady, NY (US)

(21) Appl. No.: 13/690,438

(22) Filed: Nov. 30, 2012

Related U.S. Application Data
(63) Continuation-in-part of application No. 13/436,420, filed on Mar. 30, 2012.

(51) Int. Cl. F16S 5/00

(52) U.S. Cl. CPC F16S 5/00
USPC 137/334; 29/428

(57) ABSTRACT

A flow-control device, a component, and method of producing a flow-control device are disclosed. The flow-control device includes thermally-adjustable features positioned along a surface of the flow-control device configured to be adjacent to a flow, and a heating member in direct or indirect contact with the thermally-adjustable features. The thermally-adjustable features deploy from or retract toward the surface in response to a predetermined temperature change provided by the heating member. The deploying from or the retracting toward of the thermally-adjustable features increases or decreases turbulation of the flow along the surface. The component includes the flow-control device. The method includes forming the thermally-adjustable features along the surface of the flow-control device, in direct or indirect contact with a heating member. The thermally-adjustable features deploy from or retract toward the surface in response to a predetermined temperature change provided by the heating member.

### CROSS-REFERENCE TO RELATED APPLICATION

This application is a continuation-in-part of U.S. Utility application Ser. No. 13/436,420, filed Mar. 30, 2012, and entitled “COMPONENTS HAVING TAB MEMBERS,” the disclosure of which is incorporated by reference in its entirety.

### FIELD OF THE INVENTION

The present invention is directed to flow-control devices, components having flow-control devices, and methods of producing flow-control devices. More specifically, the present invention is directed to flow-control devices with thermally-adjustable features.

### BACKGROUND OF THE INVENTION

Airfoils of all kinds are subject to a condition called stall when the angle of attack becomes so great that a boundary layer on top of the airfoil separates from the surface of the airfoil, decreasing or completely eliminating lift. For aircraft this poses an extreme safety risk. For wind turbines, this means non-operability in lower wind speeds and possibility of tower strikes in the event of stall induced vibrations. For turbine engine blades, mechanical damage can be created by the stall induced vibrations. Additionally, any of the above mentioned applications of airfoils can build up ice on the foil, which will also cause a stall condition and/or cause other damage.

To combat such stall conditions, vortex generators are used. Vortex generators delay flow separation and aerodynamic stalling, thereby improving the effectiveness of wings and control surfaces. Vortex generators are normally in the form of tiny strips of metal or plastic placed on top of the wing, near the leading edge of a blade, and they protrude past the boundary layer into the free stream. These serve to energize the boundary layer by mixing free stream airflow with the boundary layer flow and/or converting laminar flow into turbulent flow, which creates vortices. These vortices increase inertia of the boundary layer, which can delay or prevent airflow separation from the airfoil and resulting stall. Similarly, such vortex generators can increase wing stability.

Current technology for moving the vortex generators relies on small motors. Small motors require power sources, can mechanically fail, and can be limited in application. For example, small motors can require electricity or combustion of hydrocarbon fuels to power the motors. Such power sources are not always readily available and/or can be hazardous in certain applications. Small motors can include rotating parts and/or other mechanisms that are subject to wear, especially in harsh environments. Such rotating parts and/or other mechanisms can be too large for certain applications or can otherwise interfere with operation of certain applications. Small motors are also limited in applications by requiring periodic maintenance, which can limit operational use of components having such small motors, thereby decreasing efficiency of applications utilizing them. Also, transitioning such vortex generators from being disengaged to engaged can cause rough transitions and/or decreased efficiency.

A flow-control device, a component having a flow-control device, and a method of producing a flow-control device not suffering from the above drawbacks would be desirable in the art.

### BRIEF DESCRIPTION OF THE INVENTION

In an exemplary embodiment, a flow-control device includes thermally-adjustable features positioned along a surface of the flow-control device configured to be adjacent to a flow, and a heating member in direct or indirect contact with the thermally-adjustable features. The thermally-adjustable features deploy from or retract toward the surface in response to a predetermined temperature change provided by the heating member. The deploying from or the retracting toward of the thermally-adjustable features increases or decreases turbulation of the flow along the surface.

In another exemplary embodiment, a component having a flow-control device includes thermally-adjustable features on the component along a surface of the flow-control device configured to be adjacent to a flow. The thermally-adjustable features are in direct or indirect contact with a heating member. The thermally-adjustable features deploy from or retract toward the surface in response to a predetermined temperature change provided by the heating member.

In another exemplary embodiment, a method of producing a flow-control device includes forming thermally-adjustable features along a surface of a flow-control device configured to be adjacent to a flow. The thermally-adjustable features are positioned in direct or indirect contact with a heating member. The thermally-adjustable features deploy from or retract toward the surface in response to a predetermined temperature change provided by the heating member.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic view of an exemplary component according to an embodiment of the disclosure.

FIG. 2 is a schematic view of an exemplary component according to an embodiment of the disclosure.

FIG. 3 is a schematic view of an exemplary component according to an embodiment of the disclosure.

FIG. 4 is a schematic view of a portion of an exemplary component according to an embodiment of the disclosure.

FIG. 5 is a schematic view of a portion of an exemplary component according to an embodiment of the disclosure.

FIG. 6 is a schematic view of a portion of an exemplary airfoil according to an embodiment of the disclosure.

FIG. 7 is a schematic view of a portion of an exemplary wind turbine blade according to an embodiment of the disclosure.

FIG. 8 is a schematic view of a portion of an exemplary power generation turbine blade according to an embodiment of the disclosure.

FIG. 9 is a schematic view of an exemplary propeller according to an embodiment of the disclosure.

FIG. 10 is a schematic view of an exemplary spoiler on a vehicle according to an embodiment of the disclosure.

FIG. 11 is a schematic view of an exemplary pattern for thermally-adjustable features according to an embodiment of the disclosure.

FIG. 12 is a schematic view of an exemplary pattern for thermally-adjustable features according to an embodiment of the disclosure.

FIG. 13 is a schematic view of an exemplary pattern for thermally-adjustable features according to an embodiment of the disclosure.

FIG. 14 is a schematic view of an exemplary pattern for thermally-adjustable features according to an embodiment of the disclosure.

Wherever possible, the same reference numbers will be used throughout the drawings to represent the same parts.

### DETAILED DESCRIPTION OF THE INVENTION

Provided is an exemplary flow-control device, a component having a flow-control device, and a method of producing a flow-control device. Embodiments of the present disclosure, for example, in comparison to vortex generators having small motors, delay or prevent stall conditions, permit smooth transitions to delay or prevent stall, permit transition to delay or prevent stall to be quieter or less noisy, permit additional control of boundary layers on turbulators, permit increased or decreased lift or thrust, permit deicing on blades, replace vortex generators without requiring motors, extend the applications capable of having turbulators, reduce or eliminate the use of rotating parts and/or other mechanisms that are subject to wear, reduce periodic maintenance needs, increase efficiency of various applications, or combinations thereof.

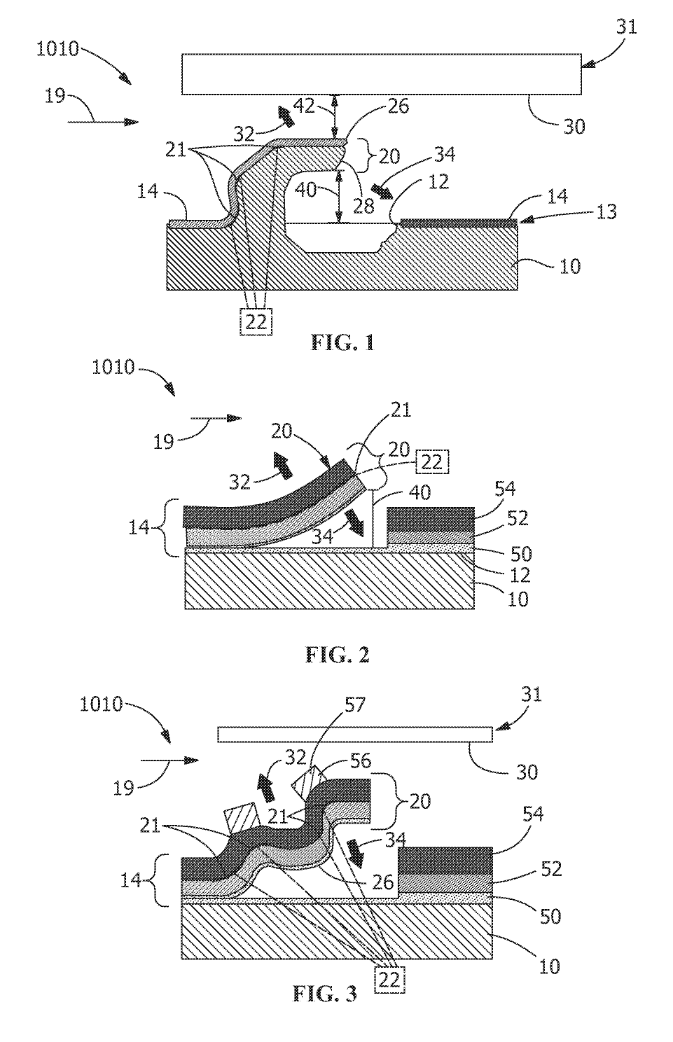

Referring to FIG. 1, in one embodiment, a flow-control device 1010 includes a structure 10 having thermally-adjustable features 20 (for example, tab members). The flow-control device 1010 is any suitable component benefiting from being capable of adjusting a flow 16 along a flow path 19 abutting a surface 13 of the flow-control device 1010, such as, those benefiting from turbulation or vortex-inducing modifications to the flow 16. The heat applied to the thermally-adjustable features 20 is by a heating member 21 in direct or indirect contact with the thermally-adjustable features 20, for example, through thermally-conductive mechanisms 22 capable of applying heating to the thermally-adjustable features 20 by being in contact with the thermally-adjustable features 20 or by being in contact with another mechanism or material capable of conducting heat to the thermally-adjustable features 20. As used herein, the phrase “thermally-adjustable” refers to being capable of physical movement based upon an induced temperature change in a direction beyond expansion and contraction. For example, such directions include, but are not limited to, those associated with flexing, bending, raising, retracting or combinations thereof. The thermally-adjustable features 20 deploy from or retract toward the surface 13 of the structure 10 in response to a predetermined temperature change.

In one embodiment, the thermally-adjustable features 20 are capable of physical movement because a first layer 12, which may coincide with the surface 13 and/or be proximal to the surface 13 in comparison to a second layer 14, includes a first metal or metallic material and the first layer 12 is directly or indirectly positioned on the second layer 14 having a second metal or metallic material, the first metal or metallic material having a different composition than the second metal or metallic material. The first layer 12 and the second layer 14 are secured by any suitable manner, such as, by diffusion bonding, electron beam welding, laser welding, brazing, spraying, sputtering, ion plasma processing, melt-solidification, direct writing, laser cladding, plating, powder melting, laser sintering, galvanizing, or a combination thereof. Suitable spraying techniques include, but are not limited to, thermal spraying, chemical vapor deposition (CVD), physical vapor deposition (PVD), plasma spraying, detonation spraying, wire arc spraying, flame spraying, high velocity oxy-fuel coating spraying (HVOF), warm spraying, cold spraying, and combinations thereof.

The structure 10 is any suitable structure coated with at least one dissimilar metallic layer. The first layer 12 and/or the second layer 14 of the structure 10 include(s) any suitable metal or metallic material. Suitable such alloys are selected from the group consisting of nickel, iron, cobalt, stainless steel, aluminum, copper, magnesium, gold, platinum, MCrAlY (wherein M is Ni, Co, Fe, or combinations thereof), alloys thereof, 304 stainless steel substrate (available from AK Steel Corporation, West Chester, Ohio), and combinations thereof. Other suitable materials include, but are not limited to, CrMoV and NiCrMo (for example, having a low thermal expansion coefficient of about 6), INCONEL° materials, such as, but not limited to, INCONEL®625, INCONEL®718 (available from Special Metals Corporation, Huntington, West Va.), (for example, having a medium thermal expansion coefficient of about 7), stainless steels, such as, but not limited to, 316 stainless steel (UNS 531600, an austenitic chromium, nickel stainless steel containing molybdenum) or 304 stainless steel (UNS 530400, a variation of the basic 18-8 grade, Type 302, with a higher chromium and lower carbon content) (available from AK Steel, West Chester, Ohio) (for example, having a high coefficient of thermal expansion of approximately 9).

The first layer 12 and the second layer 14 have dissimilar thermal expansion coefficients. The difference in thermal expansion coefficients (a) between the first layer 12 and the second layer 14 allows the thermally-adjustable features 20 to respond to the predetermined temperature change, whether induced or environmental. The first layer 12 has a first coefficient of thermal expansion (α₁) and the second layer 14 has a second coefficient of thermal expansion (α₂), the first coefficient of thermal expansion (α₁) and the second coefficient of thermal expansion (α₂) differ by a predetermined amount to achieve a desired response based upon the predetermined temperature change. Suitable differences include, but are not limited to, a difference of about 3%, about 5%, about 7%, about 10%, between about 3% and about 5%, between about 3% and about 7%, an order of magnitude of 1.1, an order of magnitude of 1.5, an order of magnitude of 2, an order of magnitude between 1.1 and 2, or any suitable combination, sub-combination, range, or sub-range thereof, an order of magnitude being based upon how much deflection is desired, given a predetermined temperature change, based upon bimetallic beam bending calculations for a given material set and feature/beam geometry.

In one embodiment, the thermally-adjustable features 20 are positioned to deploy away from the surface 13, for example, in a raising direction 32 as shown in FIGS. 1-3 in response to heat from the heating member 21. In one embodiment, the thermally-adjustable features 20 are configured for deicing, for example, by movement of the thermally-adjustable features 20 and/or by heat from the heating member 21 being applied to the thermally-adjustable features 20.

In one embodiment, the method of changing the temperature of the thermally-adjustable features 20 is the placement of a thermally-conductive member 22 between the thermally-adjustable features 20 and heating member 21, where the thermally-conductive member 22 transfers thermal energy from heating member 21 to the thermally-adjustable features 20. In one embodiment, heating member 21 is electrically conductive having an electrical resistance such that the passage of current through heating member 21 transforms direct resistance heating into thermal energy. In another embodiment, heating member 21 is a layered structure, having one or more layers where one layer has a lower conductivity resulting in a lower electrical current compared to another layer. The difference in conductivity heats one layer more than another. In one embodiment, the difference in heating one layer more than another leads to an increase or a decrease in the range of motion of an article, for example, a spoiler. In yet another embodiment, material combinations are preferentially selected to increase the range of motion, for example, a material with a high thermal expansion and a high electrical conductivity. Materials with a low thermal expansion would also work but require higher temperatures to achieve the same amount of displacement. In one embodiment, the thermally-conductive member 22 is continuous or discontinuous along the thermally-adjustable features 20.

Methods of heating thermally-adjustable features 20 include, but are not limited to, magnetic induction, resistance heating by flowing electrical current through the thermally-adjustable features 20, microwave or radio frequency heating, heating by infrared radiation, adjusting the temperature of a gas flowing around the thermally-adjustable features 20, adjusting the temperature or flow rate of coolant if the thermally-adjustable features 20 is disposed on an actively cooled part. In one embodiment, electrical current is induced by subjecting thermally-adjustable features 20 to a magnetic field. By varying the amplitude of an alternating field, for example, thermally-adjustable features 20 are disposed on a moving part such as a turbine blade. As the turbine blade moves through the stationary magnetic field, an electrical current is induced, resulting in electrical resistance heating. In another embodiment, the temperature of the thermally-adjustable features 20 is controlled by changing the field strength of the magnetic field.

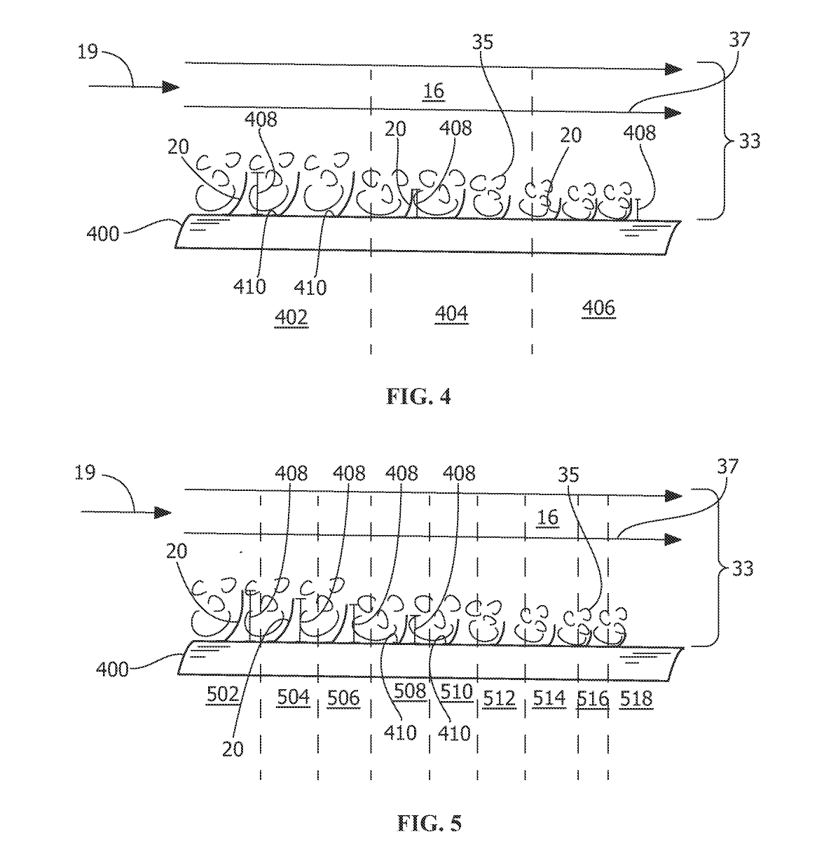

In one embodiment, the thermally-adjustable features 20 are positioned to retract toward the surface 13 in a retracting direction 34 as shown in FIGS. 1-3. To deploy away from the surface 13 in the raising direction 32, for example, toward an adjacent surface 30 to close a gap 42 and/or through a portion or all of a fluid boundary layer 33 (see FIG. 4) as is shown in FIGS. 1 and 3, and/or reduce air flow volume and/or rate in response to the predetermined temperature change being an increase in temperature, the first coefficient of thermal expansion (αₜ) is greater than the second coefficient of thermal expansion (α₂). To retract toward the surface 13 in the retracting direction 34, for example, away from the adjacent surface 30 to create and/or increase the gap 42 and/or away from the fluid boundary layer 33 (see FIG. 4) as is shown in FIGS. 1 and 3, and/or increase air flow volume and/or rate in response to the predetermined temperature change being an increase in temperature, the first coefficient of thermal expansion (α₁) is less than the second coefficient of thermal expansion (α₂). In one embodiment, the thermally-adjustable features 20, in response to the predetermined temperature, adjust in height 40 (see FIGS. 1-2), for example, from the surface 13, within a predetermined range, such as, between about 10% and about 50%, between about 15% and about 45%, between about 20% and about 30%, or any suitable combination, sub-combination, range, or sub-range therein.

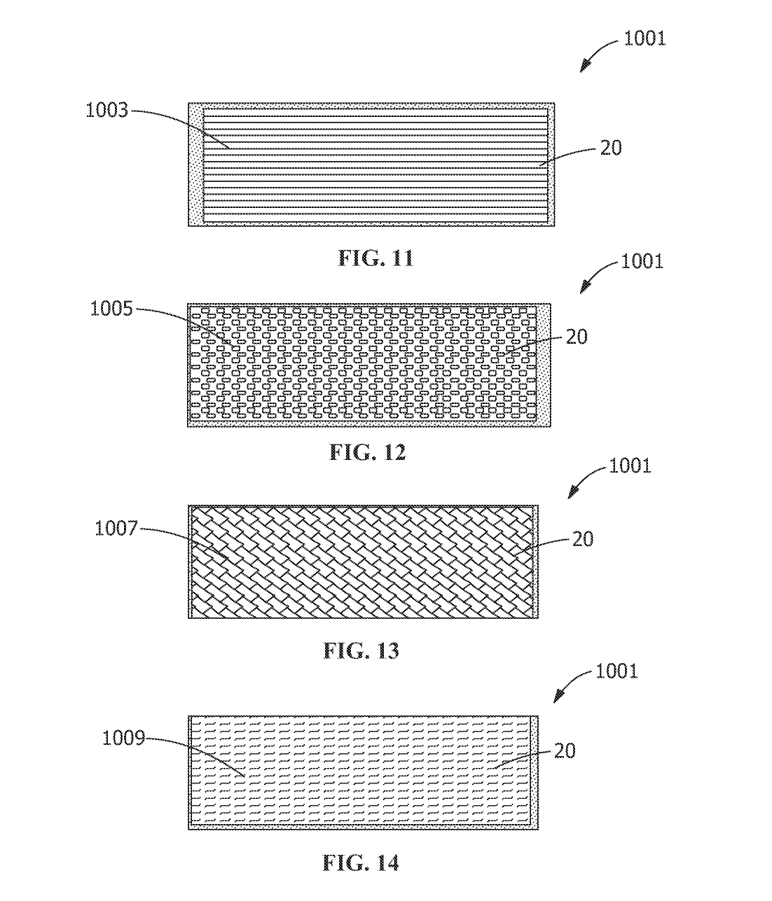

In one embodiment, the thermally-adjustable features 20 are formed by cutting or penetrating at least a portion 28 of the structure 10 and the second layer 14, thereby creating the thermally-adjustable features 20 in the surface 13 of the structure 10. Suitable methods for forming plurality of thermally-adjustable features 20, include, but are not limited to, laser surface sculpting, breaking, fracturing or disrupting a brittle layer, applying a pulsed laser, applying targeted mechanical shock and/or mechanical stress, or a combination thereof. In one embodiment, the thermally-adjustable features 20 are sculpted into means for forming a pattern 1001, such as, but not limited to, rows or lines 1003 (see FIG. 11), dashed rows/lines 1005 (see FIG. 12), fish scales 1007 (see FIG. 13), zig-zags 1009 (see FIG. 14), slots or elongate holes, other desired patterns, or a combination thereof.

Referring to FIG. 2, in one embodiment, the flow-control device 1010 restricts a flow path 19 and/or increases or otherwise modifies the flow 16, for example, as is shown in FIGS. 4 and 5. As temperature increases resulting in the predetermined temperature change, the thermally-adjustable features 20 reposition toward and/or press against the adjacent surface 30, for example, of a separate body 31 sealing and/or restricting the flow path 19 and/or extending partially or completely through the fluid boundary layer 33 increasing a proportion of the turbulent flow 35 in the flow 16 in comparison to other types of flow (such as, laminar flow 37 and/or transitional flow, not shown). In one embodiment, the flow-control device 1010 acts as a turbulator for pipe flow, such as, a twisted-tape turbulator (for example, a twisted ribbon that forces fluid to move in a helicoidal path rather than in a straight line), a Brock turbulator (for example, a zig-zag folded ribbon), a wire turbulator (for example, an open structure of looped and entangled wires that extends over an entire pipe length), or a combination thereof. In one embodiment, the turbulent flow 35 in the flow 16 is more prevalent than other types of flow. Additionally or alternatively, the thermally-adjustable features 20 increase and/or throttle the flow path 19. For example, as temperature increases resulting in the predetermined temperature change, the thermally-adjustable features 20 retract toward the surface 13 of the sealing structure 10 and/or away from the adjacent surface 30 of separate body 31 and/or away from the fluid boundary layer 33, thereby increasing the rate and/or volume of the flow 16 through the flow path 19 and the gap 42.

Referring again to FIGS. 2 and 3, in one embodiment, the second layer 14 includes a first metallic layer 50 and a second metallic layer 52, the first metallic layer 50 being distal from the surface 13 in comparison to the second metallic layer 52. In further embodiments, the second layer 14 further includes a third metallic layer 54 and/or a fourth metallic layer 56 (see FIG. 3), the third metallic layer 54 being positioned opposite the first metallic layer on the second metallic layer 52 and the fourth metallic layer 56 being positioned proximal to the surface 13 in comparison to the third metallic layer 54. In one embodiment, the first metallic layer 50, the second metallic layer 52, the third metallic layer 54, the fourth metallic layer 56, or a combination thereof, have different thermal expansion coefficients and/or form at least a portion of the thermally-adjustable features 20.

Referring again to FIG. 3, in one embodiment, the thermally-adjustable features 20 include one or more layered portions 26, the layered portion(s) 26 including the first metallic layer 50, the second metallic layer 52, and the third metallic layer 54. In one embodiment, the first metallic layer 50 is a weaker or more brittle metallic layer than the second metallic layer 52 and/or the third metallic layer 54. As used herein, “brittle” refers to being less ductile. In one embodiment, the first metallic layer 50 is a material with a tensile elongation at failure of less than about 10%, a porosity between about 0% or 1% by volume and about 50% by volume, or a combination thereof. In a further embodiment, the first metallic layer 50 is configured to be broken when mechanical stress or other stress is applied.

The third metallic layer 54 is a strong metallic layer having a different coefficient of thermal expansion (α) than the second metallic layer 52. In one embodiment, the third metallic layer 54 is selected from a material having a coefficient of thermal expansion (α) that is up to about the same or about 20% different than the first metallic layer 50 and/or the second metallic layer 52. The 20% difference is either greater than or less than, depending on the desired movement of thermally-adjustable features 20. Misfit strain (ε) is the difference between the coefficients of thermal expansion (α) for a temperature gradient and is calculated using the following equation:

ε=(α₁−α₂)ΔT

where ε is misfit strain; α₁ and α₂ are the coefficient of thermal expansion of two layers; and ΔT is the temperature gradient, which is the current temperature minus the reference temperature. The reference temperature is the temperature at which the thermally-adjustable features 20 have no flexure or movement. In one embodiment, the predetermined temperature change results in a misfit strain of at least about 8%, for example, between the second metallic layer 52 and the third metallic layer 54.

Suitable examples of materials for the first metallic layer 50 include, but are not limited to, nickel-aluminum, titanium-aluminum, nickel-chromium carbide, cobalt-chromium carbide, alloys thereof and combinations thereof. Suitable examples of materials for the second metallic layer 52 and the third metallic layer 54 include, but are not limited to, nickel, iron, cobalt, stainless steel, aluminum, copper, magnesium, gold, platinum, MCrAlY, wherein M is Ni, Co, Fe, or combinations thereof, alloys thereof, and combinations thereof. In an embodiment where the thermally-adjustable features 20 deploy from the surface 13, (for example, in the raising direction 32), the first metallic layer 50 and/or the second metallic layer 52 have higher coefficients of thermal expansion than the coefficient of thermal expansion for the third metallic layer 54 and/or adjust in the raising direction 32 upon the predetermined temperature change being an increase in temperature. In an embodiment where the thermally-adjustable features 20 retract toward the surface 13, (for example, in the retracting direction 34), the first metallic layer 50 and/or the second metallic layer 52 have lower coefficients of thermal expansion than the coefficient of thermal expansion for the third metallic layer 54 and/or adjust in the retracting direction 34 upon the predetermined temperature change being an increase in temperature.

Referring to FIG. 3, in one embodiment, protrusions 57 are positioned on the thermally-adjustable features 20. The protrusions 57 are formed by any suitable techniques, such as, by laser sculpting the thermally-adjustable features 20. In one embodiment, the protrusions 57 are a discontinuous top layer, capable of altering the shape of the thermally-adjustable features 20 based upon differing coefficients of thermal expansion. For example, such altering is capable of generating a wavy set of thermally-adjustable features 20, increasing turbulence and/or surface thickness.

Referring to FIGS. 4 and 5, in one embodiment, thermally-adjustable features 20 are positioned along the surface 13, for example, of the flow-control devices 1010 shown in FIGS. 1-3. The thermally-adjustable features 20 deploy from or retract toward the surface 13 in response to a predetermined temperature change, thereby increasing or decreasing turbulation along the surface 13. The increase or the decrease in the turbulation increases or decreases heat transfer between the surface 13 and the flow path 19 adjacent to the surface 13. In one embodiment, the increase or the decrease in the heat transfer is a self regulating mechanism predominantly based upon an increase or decrease in convective heat transfer as a method of managing temperature within the thermally-adjustable features 20.

In one embodiment, thermally-adjustable features 20 regulate the flow 16 (for example, of air, gas, liquid, coolant, refrigerant, or any other suitable fluid) and/or heat transfer along the flow path 19. For example, by deploying/raising or retracting in response to the predetermined temperature change, the thermally-adjustable features 20 increase or decrease resistance along the flow path 19. The increase or decrease in resistance increases or decreases heat transfer. Additionally or alternatively, in one embodiment, the thermally-adjustable features 20 are positioned to provide a predetermined flow characteristic along the flow path 19, for example, the turbulent flow 35, the laminar flow 37, the transitional flow (not shown), or a combination thereof. In further embodiments, the thermally-adjustable features 20 direct the flow path 19 to spiral, divert, narrow, expand, or a combination thereof. Referring to FIG. 4, in one embodiment, the surface 13 includes two or more regions configured for operation under different flow conditions. The velocity, acceleration, proportion of the turbulent flow 35, proportion of the laminar flow 37, proportion of the transitional flow (not shown), rate of heat transfer, mixing of components within the flow 16, depth of the boundary layer 33, or a combination thereof, of the flow 16 along the flow path 19 decrease(s) or increase(s) as a result of the thermally-adjustable features 20 being deployed or retracted, thereby increasing or decreasing the surface area of the thermally-adjustable features 20. In one embodiment, the surface 13 includes a first region 402 configured for operation under predetermined flow conditions, such as a slower axial flow rate along the flow path 19, for example, due to a greater proportion of the flow 16 being the turbulent flow 35 in comparison to a second region 404 configured for operation under predetermined flow conditions, such as a faster axial flow rate along the flow path 19, for example, due to a lower proportion of the flow being the turbulent flow 35. In a further embodiment, the surface 13 includes a third region 406 with an axial flow rate that is faster than the axial flow rate within the second region, for example, due to a lower proportion of the flow 16 being the turbulent flow 35.

In one embodiment, heat transfer results in temperature differences between the first region 402, the second region 404, and/or the third region 406. Suitable temperature differences include, but are not limited to, a range of between about 10° F. and about 100° F., a range of between about 10° F. and about 50° F., a range of between about 10° F. and about 30° F., a range of between about 10° F. and about 20° F., a range of between about 20° F. and about 100° F., a range of between about 30° F. and about 100° F., a range of between about 50° F. and about 100° F., an amount greater than about 10° F., an amount greater than about 30° F., an amount greater than about 50° F., an amount of about 10° F., an amount of about 30° F., an amount of about 50° F., an amount of about 100° F., or any suitable combination, sub-combination, range, or sub-range therein.

Within each of the regions, the thermally-adjustable features 20 have a deployment length 408. The deployment length 408 is based upon the temperature proximal to the thermally-adjustable feature 20, the materials used in the thermally-adjustable feature 20, the arrangement of the materials in the thermally-adjustable feature 20, the thickness of the materials in the thermally-adjustable feature 20, or a combination thereof, and is capable of increasing or decreasing the depth of the fluid boundary layer 33. In one embodiment, the deployment length 408 of the thermally-adjustable features 20 within the first region 402 is greater than the deployment length 408 of the thermally-adjustable features 20 within the second region 404. In a further embodiment, the deployment length 408 of the thermally-adjustable features 20 within the second region 404 is greater than the deployment length 408 of the thermally-adjustable features 20 within the third region 406.

As will be appreciated by those skilled in the art, any suitable number of the regions is included. For example, in some embodiments, four regions, five regions, six regions, seven regions, eight regions, nine regions or more are included. Referring to FIG. 5, in one embodiment, the amount of the regions included corresponds to the amount of the thermally-adjustable features 20 included (for example, nine of the thermally-adjustable features 20 corresponding with a first region 502, a second region 504, a third region 506, a fourth region 508, a fifth region 510, a sixth region 512, a seventh region 514, an eighth region 516, a ninth region 518). In one embodiment, the thermally-adjustable features 20 create a substantially continuous decrease in the deployment lengths 408, for example, capable of increasing or decreasing the velocity, the acceleration, the proportion of the turbulent flow 35, the proportion of the laminar flow 37, the proportion of the transitional flow, the rate of the heat transfer, mixing of components, the depth of the fluid boundary layer 33, or a combination thereof.

The deployment length(s) 408 are any suitable length capable of resulting in a predetermined temperature profile. In one embodiment, the deployment length 408 for one of the thermally-adjustable features 20 is between 1 and 10 times greater than the deployment length 408 for another of the thermally-adjustable features 20, whether the thermally-adjustable features 20 are adjacent or separated by one or more other thermally-adjustable features 20. Other suitable differences in the deployment length 408 of one of the thermally-adjustable features 20 and another of the thermally-adjustable features 20 include, but are not limited to, being 1 time greater, 1.2 times greater, 1.4 times greater, 1.6 times greater, 3 times greater, 5 times greater, 7 times greater, 10 times greater, or any suitable combination, sub-combination, range, or sub-range therein. Additionally or alternatively, in one embodiment, the deployment length 408 of one or more of the thermally-adjustable features 20 is between about 0.01 inches and about 0.125 inches, between about 0.01 inches and about 0.05 inches, between about 0.01 inches and about 0.1 inches, between about 0.05 inches and about 0.125 inches, between about 0.08 and about 0.125 inches, between about 0.1 inches and about 0.125 inches, about 0.1 inches, about 0.05 inches, about 0.08 inches, about 0.1 inches, about 0.125 inches, or any suitable combination, sub-combination, range, or sub-range therein.

In addition to the deployment length 408, the thermally-adjustable features 20 include a length defined by a portion 410 applied to or integral with the surface 13. In embodiments with the length of the thermally-adjustable features 20 being consistent or substantially consistent among the thermally-adjustable features 20, the thermally-adjustable features 20 with the deployment length 408 being longer include the portion 410 being shorter in comparison to the thermally-adjustable features 20 with the deployment length 408 being shorter. Alternatively, in embodiments with the length of the thermally-adjustable features 20 differing among the thermally-adjustable features 20, for example, increasing/decreasing along the path of the flow path 19, the portion 410 applied to or integral with the surface 13 differs accordingly.

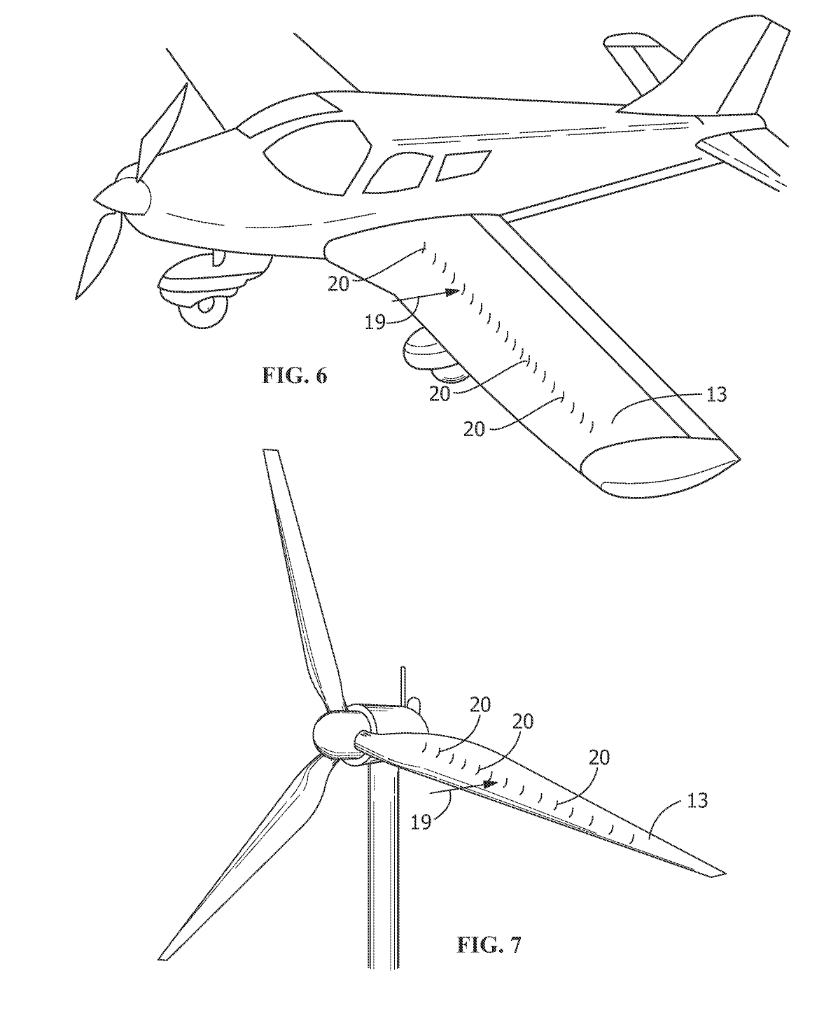

Referring to FIG. 6, in one embodiment, the thermally-adjustable features 20 are positioned on the surface 13 of an airfoil 602, such as on an airplane. As the flow 16 travels around the airfoil 602 along the flow path 19, the thermally-adjustable features 20 deploy or retract, permitting an increase or decrease in turbulation within the flow 16.

Referring to FIG. 7, in one embodiment, the thermally-adjustable features 20 are positioned on the surface 13 of a wind turbine blade 702, such as along a leading edge on the lower pressure side of the blade. As the flow 16 travels around the wind turbine blade 702 along the flow path 19, the thermally-adjustable features 20 deploy or retract in response to heat from the heating member 21, permitting an increase or decrease in turbulation within the flow 16. In one embodiment, the wind turbine blade 702 operates in lower wind speeds, without total airfoil stall, permitting a portion, such as 20% of the wind turbine blade 702, to start from a root of a wind turbine system in a stalled condition, while another portion, such as the remaining 80% of the wind turbine blade 702, operates just beyond a stall condition, thereby increasing overall energy capture of the wind turbine system for a given amount of wind.

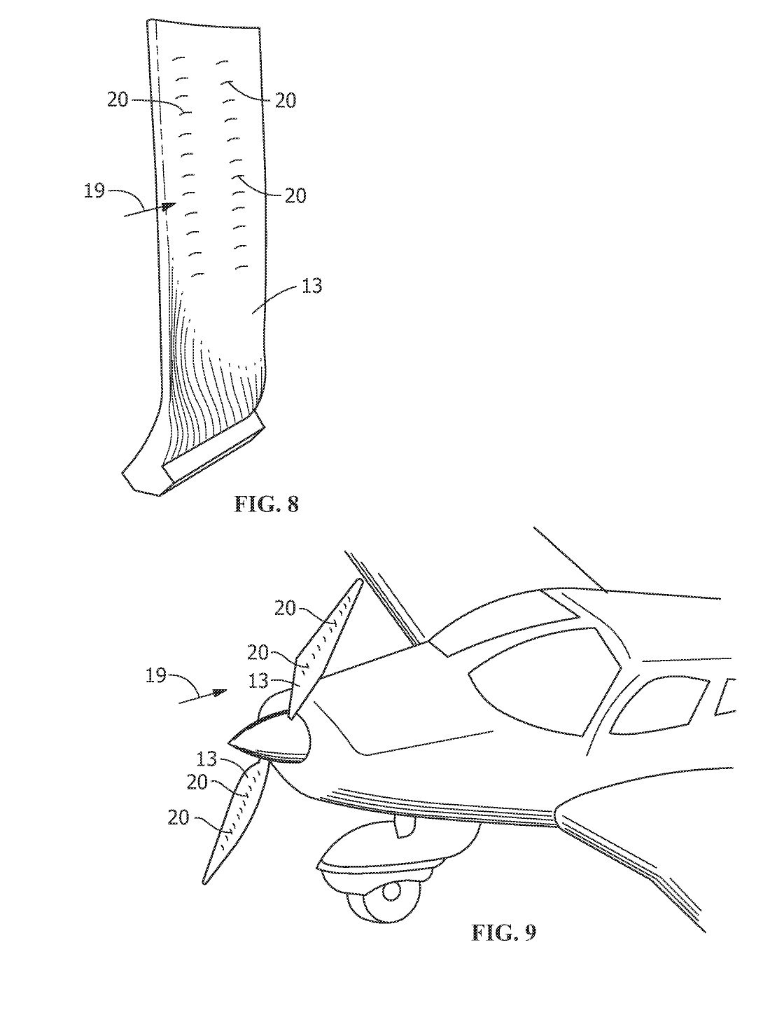

Referring to FIG. 8, in one embodiment, the thermally-adjustable features 20 are positioned on the surface 13 of a power generation turbine blade 802, such as along a leading edge on the lower pressure side of the blade. As the flow 16 travels through the power generation turbine blade 802 along the flow path 19, the thermally-adjustable features 20 deploy or retract in response to heat from the heating member 21, permitting an increase or decrease in turbulation within the flow 16.

Referring to FIG. 9, in one embodiment, the thermally-adjustable features 20 are positioned on the surface 13 of a propeller 902, such as on a plane, a helicopter, or a boat. As the flow 16 travels around the propeller 902 along the flow path 19, the thermally-adjustable features 20 deploy or retract in response to heat from the heating member 21, permitting an increase or decrease in turbulation within the flow 16.

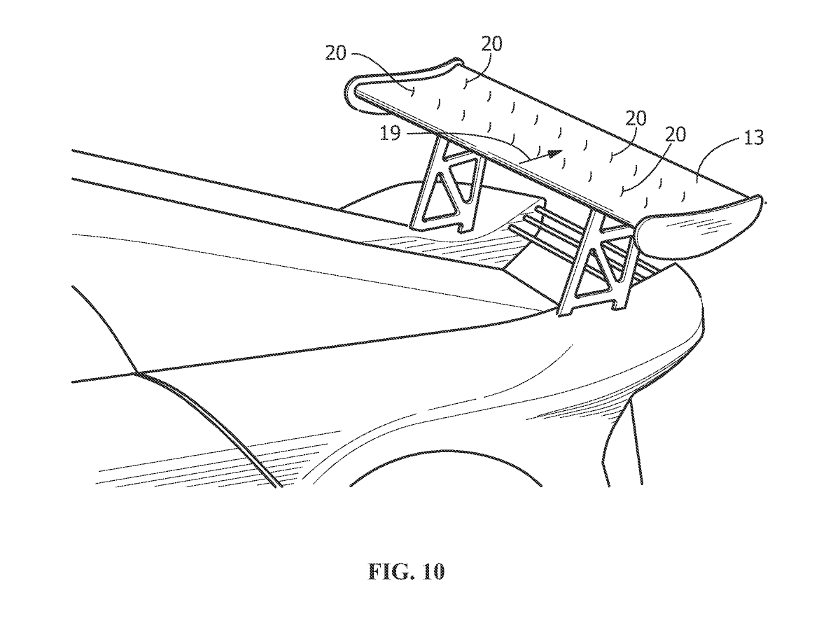

Referring to FIG. 10, in one embodiment, the thermally-adjustable features 20 are positioned on the surface 13 of a spoiler 1002, such as on a racecar, truck, ship, spacecraft, rocket, or any other vehicle. As the flow 16 travels around the spoiler 1002 along the flow path 19, the thermally-adjustable features 20 deploy or retract in response to heat from the heating member 21, permitting an increase or decrease in turbulation within the flow 16.

As will be appreciated, other embodiments include the surface 13 being positioned on surfaces benefiting from aerodynamic control, such as, but not limited to, truck cab surfaces, truck trailer surfaces, spacecraft surfaces, airplane surfaces, marine vehicle surfaces (for example, ships, boats, personal watercraft, submarines), skydiving suits, ejection pods from air or spacecraft, missiles, rockets, satellites, or any other objects intended to move through fluids. In one embodiment, the thermally-adjustable features 20 allow greater efficiency at lower speeds, for example, when used on the wind turbine blade 702 or the power generation turbine blade 802, in comparison to turbine blades that are devoid of such thermally-adjustable features 20. Similarly, in one embodiment, the thermally-adjustable features 20 allow greater lift or thrust at lower speeds, for example, when used on the airfoil 602 or the propeller 902, in comparison to airfoils or propellers that are devoid of such thermally-adjustable features 20. Also, in one embodiment, the thermally-adjustable features 20 allow greater stability, for example, when used on the spoiler 1002, in comparison to spoilers that are devoid of such thermally-adjustable features 20.

In one embodiment, the thermally-adjustable features 20 are configured to delay or prevent stall or other undesirable aerodynamic issues. For example, the thermally-adjustable features 20 permit adjustments to be made in response to an angle of the flow path 19 or a change in the angle of the flow path 19, a rate of the flow 16 or a change in the rate of the flow 16, a density of the flow 16 or a change in the density of the flow 16, or a combination thereof.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A flow-control device, comprising:
thermally-adjustable features positioned along a surface of the flow-control device configured to be adjacent to a flow;
a heating member in direct or indirect contact with the thermally-adjustable features;
wherein the thermally-adjustable features deploy from or retract toward the surface in response to a predetermined temperature change provided by the heating member;
wherein the deploying from or the retracting toward of the thermally-adjustable features increases or decreases turbulation of the flow along the surface.

2. The flow-control device of claim 1, wherein the flow is air.

3. The flow-control device of claim 1, wherein the thermally-adjustable features are configured to delay or prevent stall of an airfoil.

4. The flow-control device of claim 1, wherein the flow-control device is positioned on or is a portion of an airfoil.

5. The flow-control device of claim 1, wherein the flow-control device is positioned on or is a portion of an airplane.

6. The flow-control device of claim 1, wherein the flow-control device is positioned on or is a portion of a wind turbine.

7. The flow-control device of claim 1, wherein the flow-control device is positioned on or is a portion of a gas turbine.

8. The flow-control device of claim 1, wherein the flow-control device is positioned on or is a portion of a turbine.

9. The flow-control device of claim 1, wherein the flow-control device is positioned on or is a portion of a vane.

10. The flow-control device of claim 1, wherein the thermally-adjustable features are independently adjustable.

11. The flow-control device of claim 1, wherein the thermally-adjustable features are configured to permit adjustments to be made in response to an angle of a flow path along the surface or a change in the angle of the flow path, permit adjustments to be made in response to a rate of the flow or a change in the rate of the flow, permit adjustments to be made in response to a density of the flow or a change in the density of the flow, or a combination thereof.

12. A component having a flow-control device, comprising:
thermally-adjustable features on the component along a surface of the flow-control device configured to be adjacent to a flow;
wherein the thermally-adjustable features are in direct or indirect contact with a heating member;
wherein the thermally-adjustable features deploy from or retract toward the surface in response to a predetermined temperature change provided by the heating member.

13. The component of claim 12, wherein the thermally-adjustable features are configured to delay or prevent stall of an airfoil.

14. The component of claim 12, wherein the component is positioned on or is a portion of an airfoil.

15. The component of claim 12, wherein the component is positioned on or is a portion of an airplane.

16. The component of claim 12, wherein the component is positioned on or is a portion of an airfoil.

17. The component of claim 12, wherein the component is positioned on or is a portion of a wind turbine.

18. The component of claim 12, wherein the component is positioned on or is a portion of a turbine.

19. The component of claim 12, wherein the component is positioned on or is a portion of a vane.

20. A method of producing a flow-control device, comprising:
forming thermally-adjustable features along a surface of a flow-control device configured to be adjacent to a flow;
wherein the thermally-adjustable features are positioned in direct or indirect contact with a heating member;
wherein the thermally-adjustable features deploy from or retract toward the surface in response to a predetermined temperature change provided by the heating member.
